(19) United States
(12) Patent Application Publication
(10) Pub. No.: US 2026/0234404 A1
(43) Pub. Date: Aug. 13, 2026

(54) NEW CLASS OF DISPERSE AZO DYES, A PROCESS FOR THE PREPARATION THEREOF AND THE USE THEREOF

(71) Applicant: ARCHROMA (SWITZERLAND) GmbH, Pratteln (CH)

(72) Inventors: Ralf PETERMANN, Basel (CH); Urs LAUK, München (DE); Simon PFISTER, Gempen (CH); Patric NOWACK, Steinen (DE); Kevin MURER, Ettingen (CH); Romeo DREIER, Fehren (CH); Anton ANDREOLI, Itingen (CH); Kaja Dorota SITKOWSKA, Allschwil (CH)

(73) Assignee: ARCHROMA (SWITZERLAND) GmbH, Pratteln (CH)

(21) Appl. No.: 19/157,080

(22) PCT Filed: Feb. 15, 2024
(86) PCT No.: PCT/EP2024/053847

§ 371 Date: Aug. 15, 2025

(30) Foreign Application Priority Data
Feb. 17, 2023 (DE) 23157311.4

(51) Int. Cl. C09B 29/14; C09B 67/22; D06P 1/18; D06P 5/24; D06P 5/30

(52) U.S. Cl. CPC C09B 29/14; C09B 67/0051; D06P 1/18; D06P 5/003; D06P 5/30; D10B 2331/04; D10B 2401/021; D10B 2401/14

(57) ABSTRACT

The instant invention relates to azo dye of formula (1)

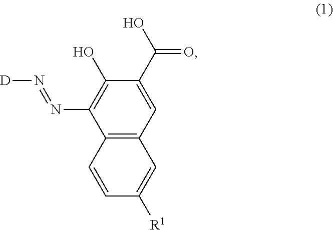

to dye mixtures comprising said azo dye, to a process for preparing said azo dyes, to specific uses of said azo dyes and to semi-synthetic or synthetic hydrophobic fiber material, dyed or printed by said azo dyes or said dye mixtures.

The present invention relates to azo disperse dyes based on BON acid (2-hy-droxynaphthalene-3-carboxylic acid) or derivatives of BON acid as the coupling component and to dye mixtures comprising said azo dyes. The present invention further relates to a process to produce such azo dyes, to their use for dyeing or printing semi-synthetic and synthetic hydrophobic fiber materials, in particular textile materials and to semi-synthetic or synthetic hydrophobic fiber materials dyed or printed by said azo dyes of said dye mixture.

Azo dyes based on BON-acid as the coupling component are known for many years. The dyes come into consideration for various dyeing applications. The salts of some BON acid monoazo dyes, such as the copper or barium salts, are used as lake, for example, Pigment Red 64.

So far, BON acid azo dyes are rarely described for the coloring of synthetic textile materials. Related technical literature dates to the 1960ies and 1970ies. Textile applications using BON acid azo dyes in the free acid form or as the alkaline- or earth alkaline metal salt are limited to the coloring of poly propylene fibers as described, for example, in U.S. Pat. No. 3,758,270. However, these attempts turned out to be not very successful.

Some azo dyes based on BON-acid are described for the dyeing of polyester fibers. However, in this case the BON-acid coupling component is used as the am-ide as described, for example, in DE 2 612 964 and DE 2 643 801. The documents are almost silent on the dyeing of polyester fibers using BON-acid azo dyes in the free acid form.

In one instance, F. Urseanu et al. Revista de Chimie, 36 (6), 450-495 (1985) describes a single azo dye synthesized by coupling 4-aminobenzanilinde on BON-acid, which has a poor build up on polyester substrates, so it is unsuitable for practical applications.

Surprisingly, it has now been found that new azo dyes according to claim 1, in particular of the formula (1) based on BON acid (or derivatives of BON acid) as the coupling compound and diazo compounds of the formula (2) show excellent results in terms of lightfastness and washing fastness.

In particular, the present invention relates to
azo dyes of formula (1)

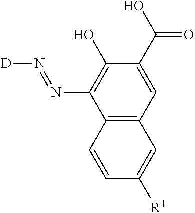

wherein R¹ denotes hydrogen, halogen, nitro, cyano or C₁-C₄alkoxy, preferably hydrogen, bromine or methoxy,
wherein D denotes a radical of formula

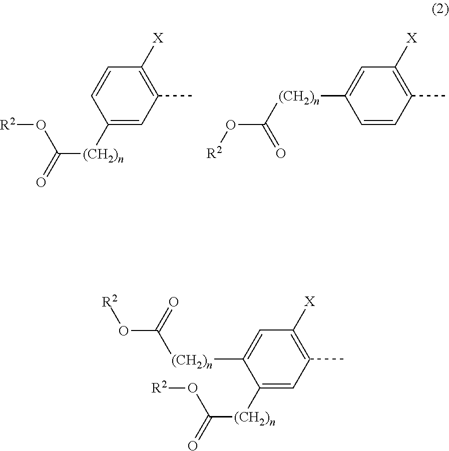

wherein n denotes as a number between 1 and 6,
wherein R² denotes C₁-C₁₂ alkyl chains which are unsubstituted or substituted by one or more C₁-C₁₂ alkoxy groups, C₁-C₁₂ alkylcarbonyl groups, C₇-C₂₅ aryl groups, C₇-C₂₅ arylcarbonyl groups, hydroxyl groups, amino groups, cyano groups or halogen atoms or it denotes aryl groups which may be substituted by C₁-C₁₂ alkyl groups which are unsubstituted or substituted by one or more C₁-C₁₂ alkoxy groups, C₁-C₁₂ alkylcarbonyl groups, C₇-C₂₅ arylcarbonyl groups, hydroxyl groups, amino groups, cyano groups or halogen atoms and which may be interrupted one or more times by the radical —O—, —S—, —NR₂—, —COO— or —OOC—, and
wherein X denotes hydrogen, halogen, preferably bromine or chlorine, nitro, C₁-C₆ alkyl, preferably methyl, or three fluoro methyl.

Preferably R¹ denotes hydrogen, bromine or methoxy.

Preferably X denotes hydrogen, methyl, chloro, or three fluoro methyl.

Preferably n denotes as a number between 1 and 4.

Preferably, n denotes 1, 2, 3 or 4, more preferably 1, 2 or 3, and in particular 1 or 2.

Preferably R² denotes methyl, ethyl, n-propyl, iso-propyl, n-butyl, n-pentyl, n-hexyl, 2-methoxy-ethyl, 2-ethyoxy-ethyl, 2-(n-propoxy)-ethyl, 2-(n-butoxy)-ethyl, 2-eth-oxy-iso-propyl, 2-(2-methoxyethoxy)ethyl, 2-(2-ethoxyethoxy)ethyl, benzyl, 2-phenylethyl, methoxy-carbonyl-methyl, ethoxy-carbonyl-methyl.

The present invention is also related to a process for the preparation of an azo dye represented by the formula (1), in particular as defined above, which comprises the diazotization of an amine compound D-NH2 in accordance with a common procedure, and afterwards the coupling reaction of the diazotized amine compound to a BON-Acid (2-hydroxynaphthalene-3-carboxylic acid) coupling component of the formula

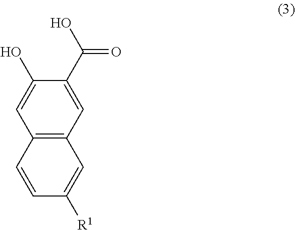

wherein R¹ are as defined and preferred above.

All definitions and preferred embodiments as set forth above with respect to the azo dye of formula (1) apply analogously to the instantly described method.

The diazotization of the amine compound D-NH2 is carried out in a manner known per se, for example with sodium nitrite in an acidic, e.g. hydrochloric-acid-containing or sulfuric-acid-containing, aqueous medium. The diazotization may, however, also be carried out using other diazotisation agents, e.g. nitrosylsulfuric acid. An additional acid may be present in the reaction medium during the diazotization, e.g. phosphoric acid, sulfuric acid, acetic acid, propionic acid or hydrochloric acid or a mixture of such acids, e.g. a mixture of propionic acid and acetic acid. The diazotization is advantageously carried out at temperatures of from −10 to 30° C., for example of from −10° C. to room temperature, particularly of from −5 to 10° C.

The coupling reaction of the diazotized amine compound D-NH2 to the BON-Acid coupling component of formula (3) is likewise accomplished in known manner, for example in an acidic, neutral or alkaline aqueous or aqueous-organic medium, advantageously at temperatures of from 0 to 30° C., especially below 20° C.

The BON-acid coupling component of formula (3) is known or can be prepared in a manner known per se, as described, for example, in U.S. Pat. Nos. 1,503,984, 1,947,819 and DE 561 425.

The present invention also relates to the azo dyes obtained by the before mentioned process.

The dye of formula (1), in particular as defined above can advantageously be used in admixture with other dyes for the preparation of mixed shades, for example, red shades.

Accordingly, the present invention further relates to dye mixtures, wherein the dye of formula (1) is used in admixture with at least one further dye selected from the group consisting of C.I. Disperse Red 050, C.I. Disperse Red 060, C.I. Disperse Red 072, C.I. Disperse Red 082, C.I. Disperse Red 86:1, C.I. Disperse Red 167, C.I. Disperse Red 277, C.I. Disperse Red 279, C.I. Disperse Red 302, C.I. Disperse Red 302:1, C.I. Disperse Red 342, C.I. Disperse Red 349, C.I. Disperse Red 356, C.I. Disperse Red 362, C.I. Disperse Red 376, C.I. Disperse Red 377, C.I. Disperse Red 378, C.I. Disperse Red 380, C.I. Disperse Red 383, C.I. Disperse Red 385 and/or the dye of formula

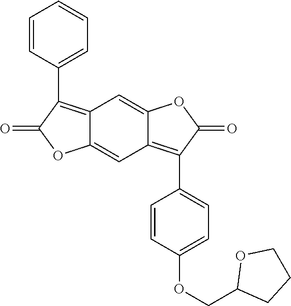 [SMILES: O=C1Oc2cc3c(cc2=C1c1ccccc1)OC(=O)C=3c1ccc(OCC2CCCO2)cc1]

The amount of the individual dyes in the dye mixtures can vary within a wide range.

The dyes and dye mixtures according to the invention can be used in the dyeing or printing of semi-synthetic and, especially, synthetic hydrophobic fiber materials, more especially textile materials. Textile materials composed of blends that contain such semi-synthetic and/or synthetic hydrophobic fiber materials can likewise be dyed or printed using the dyes or dye mixtures according to the invention.

The amount of the individual dyes in the dye mixtures can vary within a wide range. Dyeings obtained in accordance with the inventive process are distin-guished by level color shades having very good in-use fastness properties such as, especially, good fastness to light, fastness to heat setting, fastness to pleating, fastness to chlorine, and wet fastness, e.g. fastness to water, to perspiration and to washing; the finished dyeings are further characterized by very good fastness to rubbing. Special emphasis should be given to the good all-round fastness properties of the dyeings and their outstanding brightness.

Semi-synthetic fiber materials that come into consideration are, especially, cellulose 21/2-acetate and cellulose triacetate.

Synthetic hydrophobic fiber materials consist especially of linear, aromatic polyes-ters, for example those of terephthalic acid and glycols, especially ethylene gly-col, or condensation products of terephthalic acid and 1,4-bis(hydroxymethyl) cy-clohexane; of polycarbonates, e.g. those of α,α-dimethyl-4,4-dihydroxy-diphenyl-methane and phosgene, and of fibers based on polyvinyl chloride or on polyam-ide.

The application of the dyes and dye mixtures according to the invention to the fiber materials is accomplished in accordance with known dyeing methods. For example, polyester fiber materials are dyed in the exhaust process from an aqueous dispersion in the presence of customary anionic or non-ionic dispersants and, op-tionally, customary swelling agents (carriers) at temperatures of from 80 to 140° C. Cellulose 21/2-acetate is dyed preferably at temperatures of from 65 to 85° C., and cellulose triacetate at temperatures of from 65 to 115° C.

The dyes and dye mixtures according to the invention will not color wool and cot-ton present at the same time in the dyebath or will color such materials only slightly (very good reservation) so that they can also be used satisfactorily in the dyeing of polyester/wool and polyester/cellulosic fiber blend fabrics.

The dyes and dye mixtures according to the invention are suitable for dyeing in accordance with the thermosol process, in the exhaust process and for printing processes. In such processes, the said fiber materials can be in a variety of pro-cessing forms, e.g. in the form of fibers, yarns or nonwoven, woven or knitted fabrics.

It is advantageous to convert the dyes and dye mixtures according to the invention into a dye preparation prior to use. For this purpose, the dye is ground so that its particle size is on average from 0.1 to 10 microns. Grinding can be carried out in the presence of dispersants. For example, the dried dye is ground together with a dispersant or kneaded into a paste form together with a dispersant and then dried in vacuo or by atomization. After adding water, the resulting prepara-tions can be used to prepare printing pastes and dyebaths.

For printing, the customary thickeners will be used, e.g. modified or unmodified natural products, for example alginates, British gum, gum arabic, crystal gum, lo-cust bean flour, tragacanth, carboxymethyl cellulose, hydroxyethyl cellulose, starch or synthetic products, for example polyacrylamides, polyacrylic acid or co-polymers thereof, or polyvinyl alcohols.

The dyes and dye mixtures according to the invention are also suitable as colorants for use in recording systems. Such recording systems are, for example, commercially available ink-jet printers for paper or textile printing, or writing instru-ments, such as fountain pens or ballpoint pens, and especially ink-jet printers. For that purpose, the dyes according to the invention are first brought into a form suitable for use in recording systems. A suitable form is, for example, an aqueous ink, which comprises the dyes according to the invention as colorants. The inks can be prepared in customary manner by mixing the individual compo-nents, if necessary, in combination with suitable dispersing agents, in the desired amount of water.

The dyes and dye mixtures according to the invention impart to the said materials, especially to polyester materials, level color shades having very good in-use fastness properties such as, especially, good fastness to light, fastness to heat setting, fastness to pleating, fastness to chlorine, and wet fastness, e.g. fastness to water, to perspiration and to washing; the finished dyeings are further characterized by very good fastness to rubbing. Special emphasis should be given to the good all-round fastness properties of the dyeings and their outstanding brightness.

Furthermore, the dyes and dye mixtures according to the invention are also well suited to dyeing hydrophobic fiber materials from supercritical CO2.

The present invention relates to the above-mentioned use of the dyes and dye mixtures according to the invention as well as to a process for the dyeing or printing of semi-synthetic or synthetic hydrophobic fiber materials, especially synthetic hydrophobic fiber materials, and more especially textile materials, in which process a dye according to the invention is applied to the said materials or incor-porated into them. The said hydrophobic fiber materials are preferably textile polyester materials.

In the case of the ink-jet printing method, individual droplets of ink are sprayed onto a substrate from a nozzle in a controlled manner. It is mainly the continuous ink-jet method and the drop-on-demand method that are used for that purpose. In the case of the continuous ink-jet method, the droplets are produced continu-ously, droplets not required for the printing operation being discharged into a re-ceptacle and recycled. In the case of the drop-on-demand method, on the other hand, droplets are generated as desired and used for printing; that is droplets are generated only when required for the printing operation. The production of the droplets can be accomplished, for example, by means of a piezo ink-jet head or by thermal energy (bubble jet). Preference is given to printing by means of a piezo ink-jet head and to printing according to the continuous ink-jet method.

The invention relates also to hydrophobic fiber materials, preferably polyester textile materials, dyed or printed by the said processes.

The dyes according to the invention are, in addition, suitable for modern repro-duction processes, e.g. thermotransfer printing.

Hence, one further aspect of the instant invention it the use of a dye of formula (1) as defined above or a dye mixture as defined above in dyeing or printing semi-synthetic or synthetic hydrophobic fiber materials, and especially synthetic hydrophobic fiber materials, more especially textile polyester materials, and one further aspect of the instant invention is a semi-synthetic or synthetic hydrophobic fiber material, especially a textile polyester material, dyed or printed by the dye of formula (1) as defined above or by the dye mixture as defined above.

The Examples that follow serve to illustrate the invention. Parts therein are parts by weight and percentages are percentages by weight, unless otherwise indi-cated. Temperatures are given in degrees Celsius. The relationship between parts by weight and parts by volume is the same as between grams and cubic centime-ters.

### EXAMPLES

### I. Preparation Examples

### I.1 Synthesis of Precursor

### I.1.1 Synthesis of the Diazotizing Component for Dye (100)

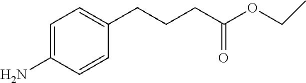

The synthesis of the diazotizing component for of dye (100) is starting with 4-Phenylbutanoic acid which can be obtained by Friedel-Crafts Acylation like it is described in J.Cai et al. Bioorg.Med. Chem. 23 (2015) S.657-667 or WO2019202607 and followed by a Clemensen Reduction as it is described in L. M. Elmore J.Am. Chem.Soc. 1936, 58, 8, S.1438-1442.

In a first step, 4-Phenylbutanoic acid is nitrated.

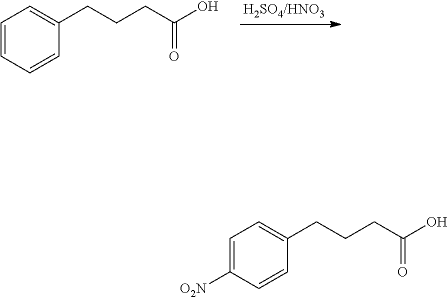 [SMILES: O=C(O)CCCc1ccccc1 ; O=C(O)CCCc1ccc([N+](=O)[O-])cc1]

50.0 g of 4-phenylbutyric acid are given to 75.0 g of deionized water. After cooling to 0° C., 485.0 g of sulfuric acid (95%) are added dropwise, followed by the dropwise addition of 33.0 g of nitric acid (65%) at 0-12° C. Afterwards 170.0 g of water are added, with the temperature rising to 32° C. After the addition of a further 200 g of water, the reaction mass is left to stir in the cold overnight. The precipitated crystals are filtered off and washed neutral with water. The purification—removal of the ortho isomer—is carried out by column filtration (tolu-ene/ethanol 2:1). Yield: 40.2 g (pale yellow solid) of 4-(4-nitrophenyl) butanoic acid.

¹H-NMR (CDCl3, 400 MHz): δ=8.18, 7.38 (AA′BB′, 4H, aromat. H), 2.82 (t, 2H, CH2), 2.44 (t, 2H, CH₂), 2.03 (m, 2H, CH₂).

The second step comprises the reduction of 4-(4-nitrophenyl) butanoic acid to 4-(4-nitrophenyl) butanoic acid.

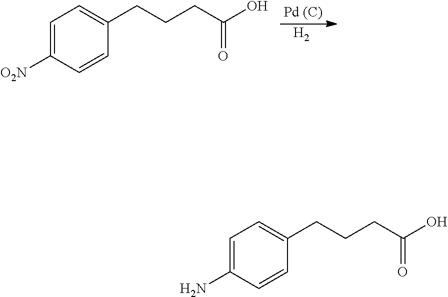

50.70 g of 4-(4-nitrophenyl) butyric acid was added to 500 ml of methanol followed by the addition of 4.10 g of sodium bicarbonate and 2.55 g of palladium (5% on charcoal). 15.7 liters of hydrogen (1 bar pressure) are added over the course of 2 hours. After the reaction has ended, the reaction mixture is filtered off from the catalyst and the filtrate is evaporated in vacuo. Yield: 43.35 g (99.8%) dark grey solid.

¹H-NMR (DMSO-d₆, 400 MHz): δ=6.82, 6.49 (AA′BB′, 4H, aromat. H), 4.88 (s broad, 2H, NH₂), 2.40 (t, 2H, CH₂), 2.17 (t, 2H, CH₂), 1.71 (m, 2H, CH₂).

The third step describes the esterification of 4-(4-nitrophenyl) butanoic acid to Ethyl 4-(4-aminophenyl) butanoate.

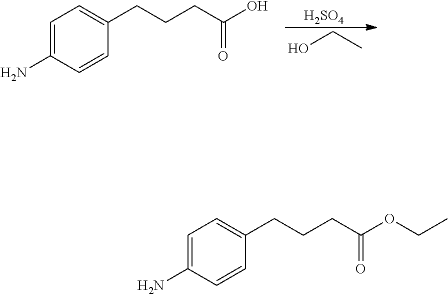

2.5 g of 4-(4-aminophenyl) butanoic acid are added to 25.0 g of ethanol followed by the addition of 4.5 g of sulfuric acid (95%) with the temperature rising to 40° C. After the reaction is finished, the reaction mixture is added to 200 g of water; a brown, clear solution is formed. The solution is neutralized with 10 g of sodium bicarbonate. The resulting emulsion is finally extracted 3 times with 60 g of toluene. The combined organic phases are dried over sodium sulphate and filtrated from the residue. After evaporation of the solvent, 2.8 g of dark oil is obtained.

¹H-NMR (CDCl₃, 400 MHz): δ=6.92, 6.62 (AA′BB′, 4H, aromat. H), 4.05 (2H, ethyl-CH₂), 2.48 (t, 2H, CH₂), 2.22 (t, 2H, CH₂), 1.81 (m, 2H, CH₂), 1.18 (t, 3H, ethyl-CH₃).

### I.1.2 Synthesis of Dye (100)

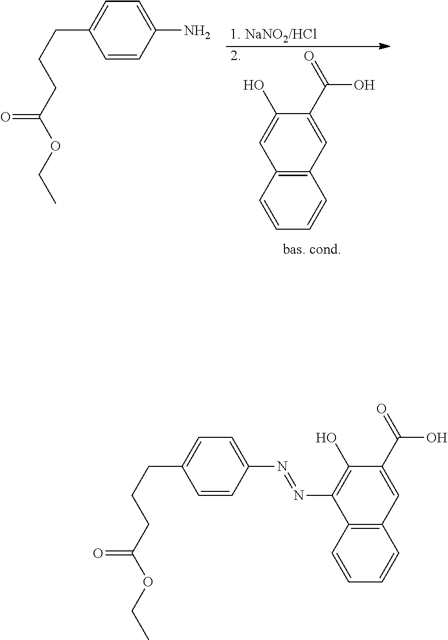

### 1. Diazotization

1.3 g of Ethyl 4-(4-aminophenyl) butanoate are added to 11.0 g of acetic acid (80%). Afterwards 7.5 g ethanol and 3.0 g water are added. The solution is cooled to 0° C. using an ice bath. After this temperature is reached, 0.9 g of hydrochloric acid (32%) and 0.7 g of sodium nitrite are added, with the temperature rising to 5° C. After two additional hours of stirring at 0° C., the diazotization is complete.

### 2. Coupling Reaction

1.2 g of Bon acid are given to 100.0 g of deionized water. Then 4.0 g of NaOH (25%) are added and the mixture was cooled to 4° C. using an ice bath. After this temperature had been reached, the diazotization solution is added dropwise at 4-12° C., while the pH value is kept between 6 and 10 by addition of 19.6 g NaOH (25%). Afterwards the ice bath is removed, and 50.0 g of water were added. The reaction mixture is allowed to stir at room temperature overnight. The mixture is suction filtered the next day and the filter cake washed with 300 g of water. The mixture of the neutralized filter cake in 350 g of water is stirred in a beaker for 15 minutes and then acidified (pH=1) with 4.0 g of 32% HCl. Finally, the red, thick suspension is suction filtered again. The filter cake is washed with 400 g of water until the filtrate is neutral. The product is dried in vacuo, Yield: 2.4 g red solid.

¹H-NMR (DMSO-d₃, 400 MHz): δ=16.23 (s, 1H, COOH), 13.49 (s, 1H, OH), 8.67 (s, 1H, naphthalin H) 8.52, 7.99, 7.74, 7.53 (ABCD, 4H, naphthalin H), 7.87, 7.40 (AA′BB′, 4H, aromat. H), 4.07 (2H, ethyl-CH₂), 2.68 (t, 2H, CH₂), 2.33 (t, 2H, CH₂), 1.87 (m, 2H, CH₂), 1.19 (t, 3H, ethyl-CH₃).

The dyes of formulae (101)-(129) listed in the following Tables 1 and 2 can be prepared in analogy to the method described above.

### II. Application Examples

### Application Example 1

1 part by weight of the dye of formula (100) according to Preparation Example 100 is milled together with four parts of a commercially available dispersing agent and 15 parts of water.

Using this formulation, a 1% dyeing (based on the dye and the substrate) is produced on woven polyester by high temperature exhaust process at 135° C.

Test results: the light fastness of the dyeing is excellent as well as the results in the AATCC 61 and ISO 105 tests. The build-up properties of the dye are very good.

### Application Examples 101 to 13

Application Example 1 is repeated by using the other dyes of Preparation Examples 101 to 135 instead of the dye of formula (100) according to Preparation Example 100.

The build-up properties of the dyes are very good and the dyeings exhibit good light fastness and very good results in the AATCC 61 and ISO 105 tests.

TABLE 1
Preparation Examples 101 to 129

| | | | λₘₐₓ |
|---|---|---|---|
| | Chemical Structure | Shade | (nm) |
| 100 | 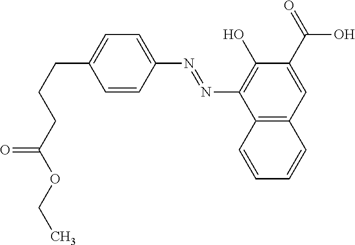 [SMILES: CCOC(=O)CCCc1ccc(/N=N/c2c(O)c(C(=O)O)cc3ccccc23)cc1] | Scarlet | 504 |
| 101 | | Red brown | 508 |
| 102 | 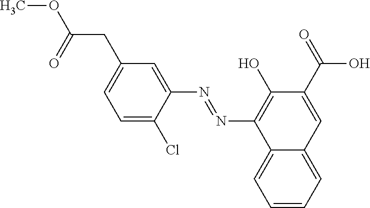 [SMILES: COC(=O)Cc1ccc(Cl)c(/N=N/c2c(O)c(C(=O)O)cc3ccccc23)c1] | Scarlet | 504 |
| 103 | 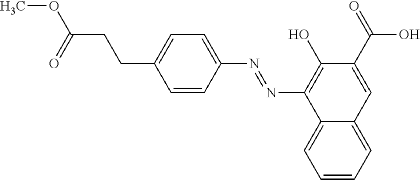 [SMILES: COC(=O)CCc1ccc(/N=N/c2c(O)c(C(=O)O)cc3ccccc23)cc1] | Bright red | 504 |
| 104 | 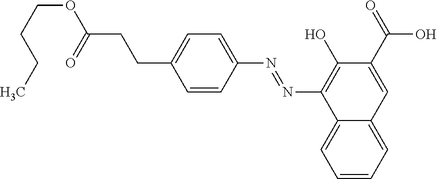 [SMILES: CCCCOC(=O)CCc1ccc(/N=N/c2c(O)c(C(=O)O)cc3ccccc23)cc1] | Bright red | 494 |
| 105 | 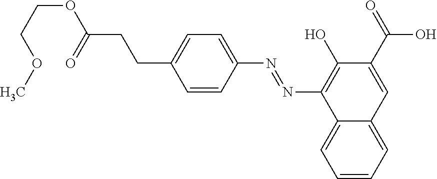 [SMILES: COCCOC(=O)CCc1ccc(/N=N/c2c(O)c(C(=O)O)cc3ccccc23)cc1] | Bright red | 508 |
| 106 | 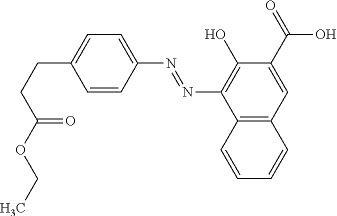 [SMILES: CCOC(=O)CCc1ccc(/N=N/c2c(O)c(C(=O)O)cc3ccccc23)cc1] | Bright red | 500 |
| 107 | 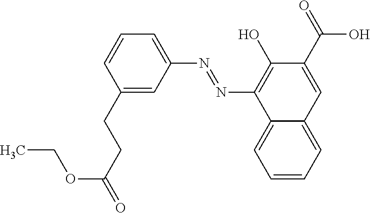 [SMILES: CCOC(=O)CCc1cccc(/N=N/c2c(O)c(C(=O)O)cc3ccccc23)c1] | Scarlet | 502 |
| 108 | 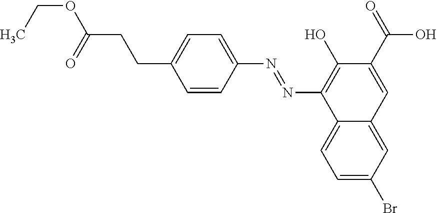 [SMILES: CCOC(=O)CCc1ccc(/N=N/c2c(O)c(C(=O)O)cc3cc(Br)ccc23)cc1] | Bright red | 514 |
| 109 | 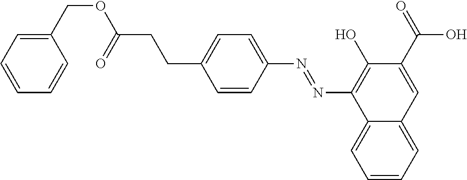 [SMILES: O=C(CCc1ccc(/N=N/c2c(O)c(C(=O)O)cc3ccccc23)cc1)OCc1ccccc1] | Scarlet | 510 |
| 110 | 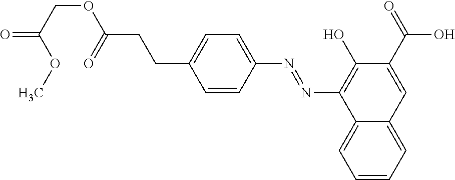 [SMILES: COC(=O)COC(=O)CCc1ccc(/N=N/c2c(O)c(C(=O)O)cc3ccccc23)cc1] | Scarlet | 508 |
| 111 | 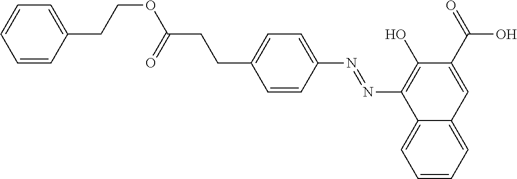 [SMILES: O=C(CCc1ccc(/N=N/c2c(O)c(C(=O)O)cc3ccccc23)cc1)OCCc1ccccc1] | Scarlet | 506 |
| 112 | 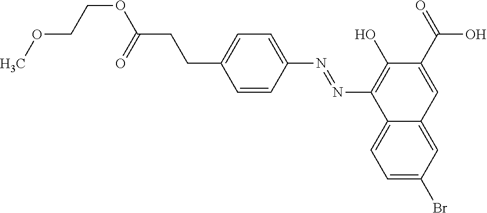 [SMILES: COCCOC(=O)CCc1ccc(/N=N/c2c(O)c(C(=O)O)cc3cc(Br)ccc23)cc1] | Bright red | 516 |
| 113 | 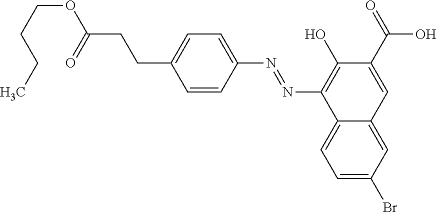 [SMILES: CCCCOC(=O)CCc1ccc(/N=N/c2c(O)c(C(=O)O)cc3cc(Br)ccc23)cc1] | Bright red | 516 |
| 114 | 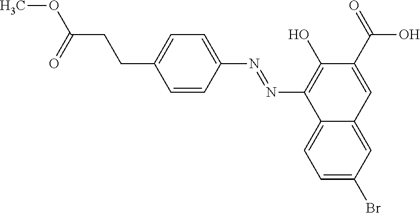 [SMILES: COC(=O)CCc1ccc(/N=N/c2c(O)c(C(=O)O)cc3cc(Br)ccc23)cc1] | Bright red | 514 |
| 115 | 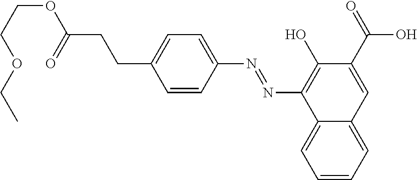 [SMILES: CCOCCOC(=O)CCc1ccc(/N=N/c2c(O)c(C(=O)O)cc3ccccc23)cc1] | Scarlet | 502 |
| 116 | 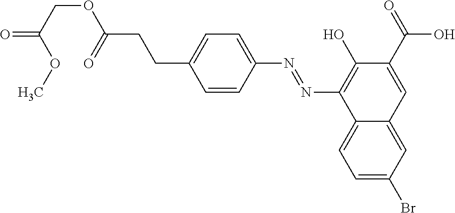 [SMILES: COC(=O)COC(=O)CCc1ccc(/N=N/c2c(O)c(C(=O)O)cc3cc(Br)ccc23)cc1] | Bright red | 498 |
| 117 | 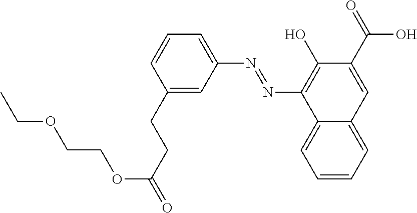 [SMILES: CCOCCOC(=O)CCc1cccc(/N=N/c2c(O)c(C(=O)O)cc3ccccc23)c1] | Scarlet | 504 |
| 118 | 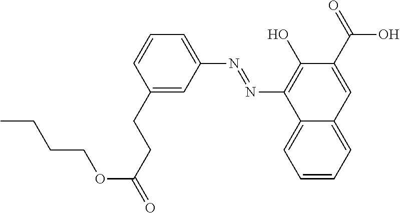 [SMILES: CCCCOC(=O)CCc1cccc(/N=N/c2c(O)c(C(=O)O)cc3ccccc23)c1] | Scarlet | 504 |
| 119 | 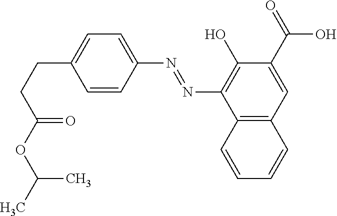 [SMILES: CC(C)OC(=O)CCc1ccc(/N=N/c2c(O)c(C(=O)O)cc3ccccc23)cc1] | Bright red | 512 |
| 121 | 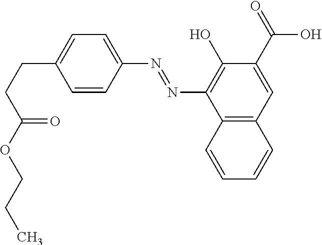 [SMILES: CCCOC(=O)CCc1ccc(/N=N/c2c(O)c(C(=O)O)cc3ccccc23)cc1] | Bright red | 512 |
| 122 | 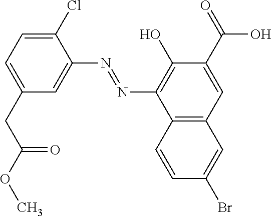 [SMILES: COC(=O)Cc1ccc(Cl)c(/N=N/c2c(O)c(C(=O)O)cc3cc(Br)ccc23)c1] | Bright red | 488 |
| 123 | 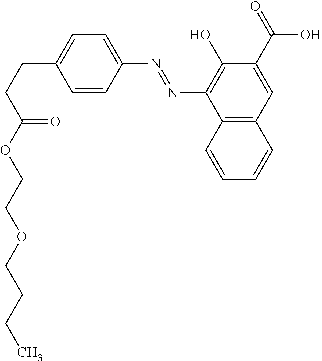 [SMILES: CCCCOCCOC(=O)CCc1ccc(/N=N/c2c(O)c(C(=O)O)cc3ccccc23)cc1] | Scarlet | 500 |
| 124 | 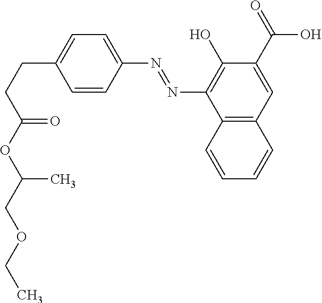 [SMILES: CCOCC(C)OC(=O)CCc1ccc(/N=N/c2c(O)c(C(=O)O)cc3ccccc23)cc1] | Scarlet | 504 |
| 125 | 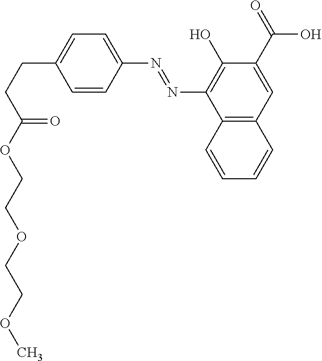 [SMILES: COCCOCCOC(=O)CCc1ccc(/N=N/c2c(O)c(C(=O)O)cc3ccccc23)cc1] | Scarlet | 492 |
| 126 | 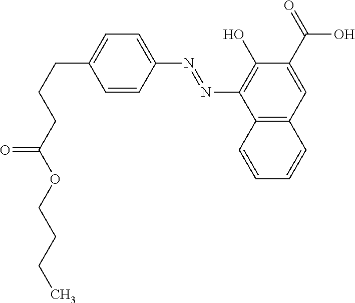 [SMILES: CCCCOC(=O)CCCc1ccc(/N=N/c2c(O)c(C(=O)O)cc3ccccc23)cc1] | Scarlet | 510 |
| 127 | 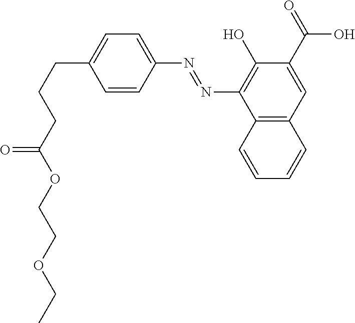 [SMILES: CCOCCOC(=O)CCCc1ccc(/N=N/c2c(O)c(C(=O)O)cc3ccccc23)cc1] | Scarlet | 514 |
| 128 | 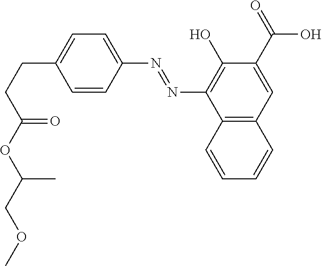 [SMILES: COCC(C)OC(=O)CCc1ccc(/N=N/c2c(O)c(C(=O)O)cc3ccccc23)cc1] | Scarlet | 492 |
| 129 | 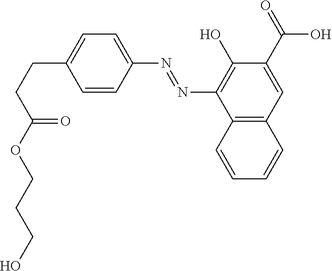 [SMILES: O=C(CCc1ccc(/N=N/c2c(O)c(C(=O)O)cc3ccccc23)cc1)OCCCO] | Scarlet | 496 |
| 130 | 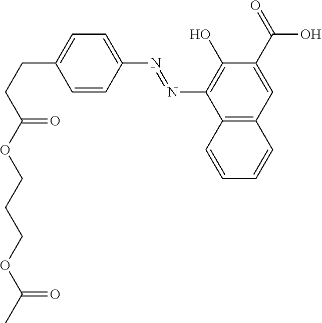 [SMILES: CC(=O)OCCCOC(=O)CCc1ccc(/N=N/c2c(O)c(C(=O)O)cc3ccccc23)cc1] | Scarlet | 506 |
| 131 | 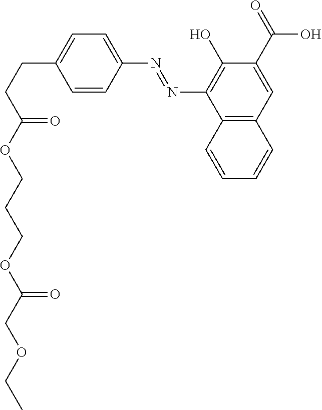 [SMILES: CCOCC(=O)OCCCOC(=O)CCc1ccc(/N=N/c2c(O)c(C(=O)O)cc3ccccc23)cc1] | Scarlet | 506 |
| 132 | 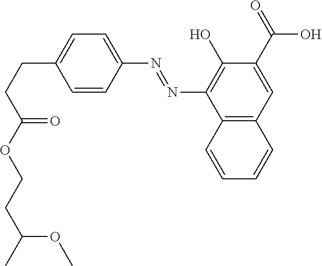 [SMILES: COC(C)CCOC(=O)CCc1ccc(/N=N/c2c(O)c(C(=O)O)cc3ccccc23)cc1] | Scarlet | 494 |
| 133 | 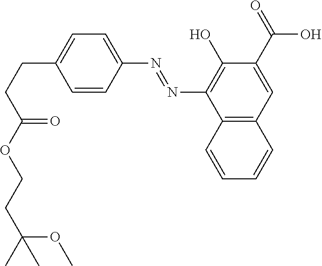 [SMILES: COC(C)(C)CCOC(=O)CCc1ccc(/N=N/c2c(O)c(C(=O)O)cc3ccccc23)cc1] | Scarlet | 496 |
| 134 | 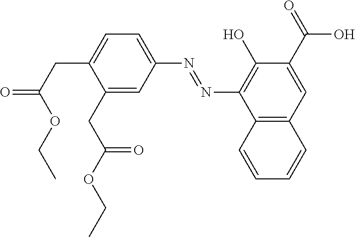 [SMILES: CCOC(=O)Cc1ccc(/N=N/c2c(O)c(C(=O)O)cc3ccccc23)cc1CC(=O)OCC] | Scarlet | 490 |
| 135 | 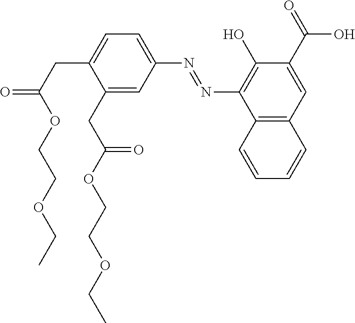 [SMILES: CCOCCOC(=O)Cc1ccc(/N=N/c2c(O)c(C(=O)O)cc3ccccc23)cc1CC(=O)OCCOCC] | Scarlet | 500 |

1. Azo dye of formula (1) 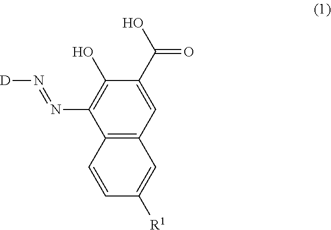
wherein R¹ denotes hydrogen, halogen, nitro, cyano or C₁-C₄alkoxy,
wherein D denotes a radical of formula 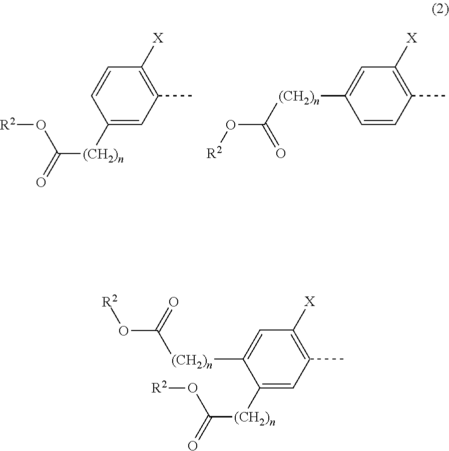
wherein n denotes a number between 1 and 6,
wherein R² denotes C₁-C₁₂ alkyl chains which are unsubstituted or substituted by one or more C₁-C₁₂ alkoxy groups, C₁-C₁₂ alkylcarbonyl groups, C₇-C₂₅ aryl groups, C₇-C₂₅ arylcarbonyl groups, hydroxyl groups, amino groups, cyano groups or halogen atoms or it denotes aryl groups which may be substituted by C₁-C₁₂ alkyl groups which are unsubstituted or substituted by one or more C₁-C₁₂ alkoxy groups, C₁-C₁₂ alkylcarbonyl groups, C₇-C₂₅ arylcarbonyl groups, hydroxyl groups, amino groups, cyano groups or halogen atoms and which may be interrupted one or more times by the radical —O—, —S—, —NR₂—, —COO— or —OOC—, and
wherein X denotes hydrogen, nitro, or C₁-C₆ alkyl.

2. Azo dye of formula (1) according to claim 1, wherein n denotes as a number between 1 and 4.

3. Azo dye of formula (1) according to claim 1, wherein R² denotes methyl, ethyl, n-propyl, iso-propyl, n-butyl, n-pentyl, n-hexyl, 2-methoxy-ethyl, 2-ethyoxy-ethyl, 2-(n-propoxy)-ethyl, 2-(n-butoxy)-ethyl, 2-ethoxy-iso-propyl, 2-(2-methoxyethoxy)ethyl, 2-(2-ethoxyethoxy)ethyl, benzyl, 2-phenylethyl, methoxy-carbonyl-methyl, ethoxy-carbonyl-methyl.

4. Process for the preparation of an azo dye of formula (1) 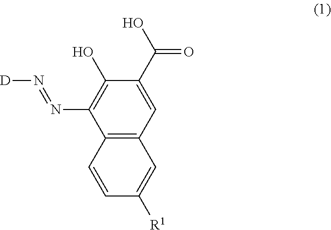
wherein R¹ denotes hydrogen, halogen, nitro, cyano or C₁-C₄alkoxy,
wherein D denotes a radical of formula (2) 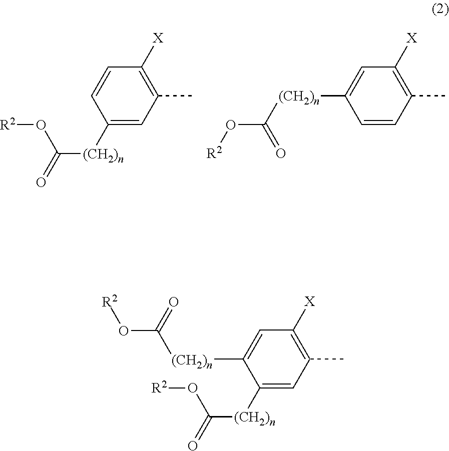
wherein n denotes a number between 1 and 6,
wherein R² denotes C₁-C₁₂ alkyl chains which are unsubstituted or substituted by one or more C₁-C₁₂ alkoxy groups, C₁-C₁₂ alkylcarbonyl groups, C₇-C₂₅ aryl groups, C₇-C₂₅ arylcarbonyl groups, hydroxyl groups, amino groups, cyano groups or halogen atoms or it denotes aryl groups which may be substituted by C₁-C₁₂ alkyl groups which are unsubstituted or substituted by one or more C₁-C₁₂ alkoxy groups, C₁-C₁₂ alkylcarbonyl groups, C₇-C₂₅ arylcarbonyl groups, hydroxyl groups, amino groups, cyano groups or halogen atoms and which may be interrupted one or more times by the radical —O—, —S—, —NR₂—, —COO— or —OOC—, and
wherein X denotes hydrogen, halogen, nitro, or C₁-C₆ alkyl,
the process comprising the diazotization of an amine compound D-NH₂ in accordance with a common procedure, and afterwards the coupling reaction of the diazotized amine compound to a BON-Acid (2-hydroxynaphthalene-3-carboxylic acid) coupling component of formula (3) 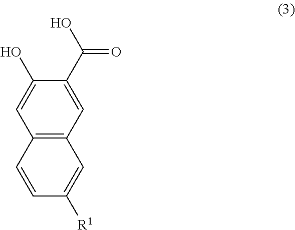
wherein R¹ is hydrogen, bromine or methoxy.

5. Dye mixtures, wherein the dye of formula (1) according to claim 1 is used in admixture with at least one further dye selected from the group consisting of C.I. Disperse Red 050, C.I. Disperse Red 060, C.I. Disperse Red 072, C.I. Disperse Red 082, C.I. Disperse Red 86:1, C.I. Disperse Red 167, C.I. Disperse Red 277, C.I. Disperse Red 279, C.I. Disperse Red 302, C.I. Disperse Red 302:1, C.I. Disperse Red 342, C.I. Disperse Red 349, C.I. Disperse Red 356, C.I. Disperse Red 362, C.I. Disperse Red 376, C.I. Disperse Red 377, C.I. Disperse Red 378, C.I. Disperse Red 380, C.I. Disperse Red 383, C.I. Disperse Red 385 and/or the dye of formula

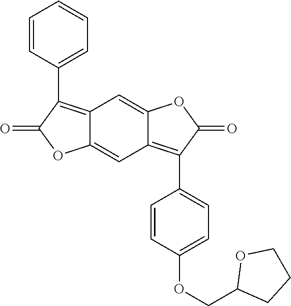 [SMILES: O=C1Oc2cc3c(cc2=C1c1ccccc1)OC(=O)C=3c1ccc(OCC2CCCO2)cc1]

6. A method of dyeing or printing semi-synthetic or synthetic hydrophobic fiber materials comprising exposing the fiber materials to the azo dye of claim 1.

7. A semi-synthetic or synthetic hydrophobic fiber material, dyed or printed by an azo dye according to claim 1.

8. The azo dye of claim 1 wherein R¹ denotes hydrogen, bromine or methoxy.

9. The azo dye of claim 1 wherein X denotes bromine, chlorine, methyl or three fluoro methyl.

10. A method of dyeing or printing semi-synthetic or synthetic hydrophobic fiber materials comprising exposing the fiber materials to the dye mixture according to claim 5.

11. A semi-synthetic or synthetic hydrophobic fiber material dyed or printed by the dye mixture according to claim 5.

12. The method of claim 6 wherein the fiber materials comprise a synthetic hydrophobic material.

13. The method of claim 12 wherein the synthetic hydrophobic material comprises textile polyester.
